(19) United States
(12) Patent Application Publication
(10) Pub. No.: US 2026/0116164 A1
(43) Pub. Date: Apr. 30, 2026

(54) DRIVE ASSEMBLY AND LAND VEHICLE

(71) Applicant: Terex South Dakota, Inc., Watertown, SD (US)

(72) Inventor: Huang YE, Xinbei Changzhou (CN)

(21) Appl. No.: 18/931,699

(22) Filed: Oct. 30, 2024

(51) Int. Cl. B60K 1/02; B60K 17/356; B60L 15/20

(52) U.S. Cl. CPC B60K 1/02; B60K 17/356; B60L 15/20

(57) ABSTRACT

A drive assembly is provided with a permanent magnet alternating current (PMAC) motor adapted to be operably connected to a vehicle chassis and a first traction device to operate the first traction device to drive the vehicle chassis along an underlying surface. An alternating current induction motor (ACIM) is adapted to be operably connected to the vehicle chassis and a second traction device to operate the second traction device to drive the vehicle chassis along the underlying surface.

### TECHNICAL FIELD

Various embodiments relate to drive assemblies for industry machinery and construction equipment, such as aerial lift assemblies.

### BACKGROUND

The prior art has provided hydraulic electric hybrid drivetrains for aerial lift platforms.

### SUMMARY

According to an embodiment, a drive assembly is provided with a permanent magnet alternating current (PMAC) motor adapted to be operably connected to a vehicle chassis and a first traction device to operate the first traction device to drive the vehicle chassis along an underlying surface. An alternating current induction motor (ACIM) is adapted to be operably connected to the vehicle chassis and a second traction device to operate the second traction device to drive the vehicle chassis along the underlying surface.

According to a further embodiment, a controller is in operable communication with the PMAC motor and the ACIM. The controller is programmed to maintain the ACIM in idle and operate the PMAC motor to provide a two-wheel drive operation to the vehicle chassis.

According to an even further embodiment, the controller is further provided with a memory.

According to another further embodiment, a controller is in operable communication with the PMAC motor and the ACIM. The controller is programmed to operate the ACIM and operate the PMAC motor to provide a four-wheel drive operation to the vehicle chassis.

According to another embodiment, a vehicle subassembly is provided with a vehicle chassis. A plurality of traction devices is connected to the vehicle chassis to support the vehicle chassis for travel along an underlying surface. A drive assembly is provided with a permanent magnet alternating current (PMAC) motor adapted to be operably connected to a vehicle chassis and a first traction device to operate the first traction device to drive the vehicle chassis along an underlying surface. An alternating current induction motor (ACIM) is adapted to be operably connected to the vehicle chassis and a second traction device to operate the second traction device to drive the vehicle chassis along the underlying surface. The PMAC motor is operably connected to the vehicle chassis and a first traction device of the plurality of traction devices. The ACIM is operably connected to the vehicle chassis and a second traction device of the plurality of traction devices.

According to a further embodiment, the first traction device is further provided with a pair of wheels.

According to an even further embodiment, the second traction device is further provided with a pair of wheels.

According to another even further embodiment, the first traction device is connected to the vehicle chassis to pivot about an upright axis for steer of the vehicle chassis.

According to another further embodiment, a first hub is connected to the vehicle chassis for rotation relative to the vehicle chassis. The first traction device is further provided with a first wheel mounted to the first hub. The PMAC motor is operably connected to the first hub.

According to an even further embodiment, a second hub is connected to the vehicle chassis for rotation relative to the vehicle chassis. The second traction device is further provided with a second wheel mounted to the second hub. The ACIM is operably connected to the second hub.

According to another embodiment, a land vehicle comprising is provided with a vehicle subassembly with a vehicle chassis. A plurality of traction devices is connected to the vehicle chassis to support the vehicle chassis for travel along an underlying surface. A drive assembly is provided with a permanent magnet alternating current (PMAC) motor adapted to be operably connected to a vehicle chassis and a first traction device to operate the first traction device to drive the vehicle chassis along an underlying surface. An alternating current induction motor (ACIM) is adapted to be operably connected to the vehicle chassis and a second traction device to operate the second traction device to drive the vehicle chassis along the underlying surface. The PMAC motor is operably connected to the vehicle chassis and a first traction device of the plurality of traction devices. The ACIM is operably connected to the vehicle chassis and a second traction device of the plurality of traction devices. Industry machinery or construction equipment is supported upon the vehicle chassis.

According to a further embodiment, the industry machinery or construction equipment is further provided as an aerial lift.

According to another embodiment, a land vehicle is provided with a vehicle chassis having a longitudinal direction of travel. A first hub is connected to the vehicle chassis for rotation relative to the vehicle chassis. A second hub is connected to the vehicle chassis for rotation relative to the vehicle chassis, the second hub being transversely spaced apart from, and transversely aligned with, the first hub. A third hub is connected to the vehicle chassis for rotation relative to the vehicle chassis, the third hub being longitudinally spaced apart from the first hub and the second hub. A fourth hub is connected to the vehicle chassis for rotation relative to the vehicle chassis, the fourth hub being transversely spaced apart from, and transversely aligned with the third hub, and longitudinally spaced apart from the first hub and the second hub. A first traction device is connected to the first hub to support the vehicle chassis for travel along an underlying surface. A second traction device is connected to the second hub to support the vehicle chassis for travel along the underlying surface. A third traction device is connected to the third hub to support the vehicle chassis for travel along the underlying surface. A fourth traction device is connected to the fourth hub to support the vehicle chassis for travel along the underlying surface. A first permanent magnet alternating current (PMAC) motor is operably connected to the first hub and the first traction device to operate the first traction device to drive the vehicle chassis along an underlying surface. A second PMAC motor is operably connected to the second hub and the second traction device to operate the second traction device to drive the vehicle chassis along the underlying surface. A first alternating current induction motor (ACIM) is operably connected to the third hub and the third traction device to operate the third traction device to drive the vehicle chassis along the underlying surface. A second ACIM is operably connected to the fourth hub and the fourth traction device to operate the fourth traction device to drive the vehicle chassis along the underlying surface. A controller is in operable communication with the first PMAC motor, the second PMAC motor, the first ACIM, and the second ACIM. The controller is programmed to maintain the first ACIM and the second ACIM in idle and operate the first PMAC motor and the second PMAC motor to provide a two-wheel drive operation to the vehicle chassis, and operate the first ACIM and the second ACIM, and to operate the first PMAC motor and the second PMAC motor, to provide a four-wheel drive operation to the vehicle chassis. Industry machinery or construction equipment is supported upon the vehicle chassis.

According to a further embodiment, the first traction device and the second traction device are connected to the vehicle chassis to pivot about upright axes for steer of the vehicle chassis.

According to another embodiment, a land vehicle is provided with a vehicle chassis having a longitudinal direction of travel. A first hub is connected to the vehicle chassis for rotation relative to the vehicle chassis and to pivot about an upright axis for steer of the vehicle chassis. A second hub is connected to the vehicle chassis for rotation relative to the vehicle chassis and to pivot about an upright axis for steer of the vehicle chassis, the second hub being transversely spaced apart from, and transversely aligned with, the first hub. A third hub is connected to the vehicle chassis for rotation relative to the vehicle chassis, the third hub being longitudinally spaced apart from the first hub and the second hub. A fourth hub is connected to the vehicle chassis for rotation relative to the vehicle chassis, the fourth hub being transversely spaced apart from, and transversely aligned with the third hub, and longitudinally spaced apart from the first hub and the second hub. A first traction device is connected to the first hub to support the vehicle chassis for travel along an underlying surface. A second traction device is connected to the second hub to support the vehicle chassis for travel along the underlying surface. A third traction device is connected to the third hub to support the vehicle chassis for travel along the underlying surface. A fourth traction device is connected to the fourth hub to support the vehicle chassis for travel along the underlying surface. A first permanent magnet alternating current (PMAC) motor is operably connected to the first hub and the first traction device to operate the first traction device to drive the vehicle chassis along an underlying surface. A second PMAC motor is operably connected to the second hub and the second traction device to operate the second traction device to drive the vehicle chassis along the underlying surface. A first alternating current induction motor (ACIM) is operably connected to the third hub and the third traction device to operate the third traction device to drive the vehicle chassis along the underlying surface. A second ACIM is operably connected to the fourth hub and the fourth traction device to operate the fourth traction device to drive the vehicle chassis along the underlying surface. A controller is in operable communication with the first PMAC motor, the second PMAC motor, the first ACIM, and the second ACIM. The controller is programmed to: maintain the first ACIM and the second ACIM in idle and operate the first PMAC motor and the second PMAC motor to provide a two-wheel drive operation to the vehicle chassis, and operate the first ACIM, the second ACIM, the first PMAC motor, and the second PMAC motor to provide a four-wheel drive operation to the vehicle chassis. Industry machinery or construction equipment is supported upon the vehicle chassis.

A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions. One general embodiment includes a drive assembly. The drive assembly also includes a permanent magnet alternating current (PMAC) motor adapted to be operably connected to a vehicle chassis and a first traction device to operate the first traction device to drive the vehicle chassis along an underlying surface. The assembly also includes an alternating current induction motor (ACIM) adapted to be operably connected to the vehicle chassis and a second traction device to operate the second traction device to drive the vehicle chassis along the underlying surface. Other embodiments of this aspect include corresponding computer systems, apparatus, and computer programs recorded on one or more computer storage devices, each configured to perform the actions of the methods.

Implementations may include one or more of the following features. The drive assembly may include a controller in operable communication with the PMAC motor and the ACIM, the controller programmed to: maintain the ACIM or the PMAC motor in idle and operate the ACIM or the PMAC motor to provide a two-wheel drive operation to the vehicle chassis. The controller further may include memory. The drive assembly may include a controller in operable communication with the PMAC motor and the ACIM, the controller programmed to: maintain the ACIM in idle and operate the PMAC motor to provide a two-wheel drive operation to the vehicle chassis. The drive assembly may include a controller in operable communication with the PMAC motor and the ACIM, the controller programmed to: operate the ACIM and operate the PMAC motor to provide a four-wheel drive operation to the vehicle chassis. The drive assembly may include a second PMAC motor adapted to be operably connected to the vehicle chassis and a third traction device to operate the third traction device to drive the vehicle chassis along the underlying surface. The drive assembly may include a second ACIM adapted to be operably connected to the vehicle chassis and a fourth traction device to operate the fourth traction device to drive the vehicle chassis along the underlying surface. The PMAC motor is operably connected to the vehicle chassis and a first traction device of the plurality of traction devices, and where the ACIM is operably connected to the vehicle chassis and a second traction device of the plurality of traction devices. The first traction device further may include a pair of wheels. The second traction device further may include a pair of wheels. The first traction device is connected to the vehicle chassis to pivot about an upright axis for steer of the vehicle chassis. The first traction device further may include a first wheel mounted to the first hub; and where the PMAC motor is operably connected to the first hub. The second traction device further may include a second wheel mounted to the second hub; and where the ACIM is operably connected to the second hub. A land vehicle may include: the vehicle subassembly and industry machinery or construction equipment supported upon the vehicle chassis. The industry machinery or construction equipment further may include an aerial lift. Implementations of the described techniques may include hardware, a method or process, or computer software on a computer-accessible medium.

One general embodiment includes a land vehicle. The land vehicle also includes a vehicle chassis having a longitudinal direction of travel. The vehicle also includes a first hub connected to the vehicle chassis for rotation relative to the vehicle chassis. The vehicle also includes a second hub connected to the vehicle chassis for rotation relative to the vehicle chassis, the second hub being transversely spaced apart from, and transversely aligned with, the first hub. The vehicle also includes a third hub connected to the vehicle chassis for rotation relative to the vehicle chassis, the third hub being longitudinally spaced apart from the first hub and the second hub. The vehicle also includes a fourth hub connected to the vehicle chassis for rotation relative to the vehicle chassis, the fourth hub being transversely spaced apart from, and transversely aligned with the third hub, and longitudinally spaced apart from the first hub and the second hub. The vehicle also includes a first traction device connected to the first hub to support the vehicle chassis for travel along an underlying surface. The vehicle also includes a second traction device connected to the second hub to support the vehicle chassis for travel along the underlying surface. The vehicle also includes a third traction device connected to the third hub to support the vehicle chassis for travel along the underlying surface. The vehicle also includes a fourth traction device connected to the fourth hub to support the vehicle chassis for travel along the underlying surface. The vehicle also includes a permanent magnet alternating current (PMAC) motor operably connected to the first hub and the first traction device to operate the first traction device to drive the vehicle chassis along an underlying surface. The vehicle also includes an alternating current induction motor (ACIM) operably connected to the third hub and the third traction device to operate the third traction device to drive the vehicle chassis along the underlying surface. The vehicle also includes a controller in operable communication with the PMAC motor and the ACIM, the controller programmed to: maintain the ACIM or the PMAC motor in idle and operate the ACIM or the PMAC motor to provide a two-wheel drive operation to the vehicle chassis, and operate the ACIM and operate the PMAC motor to provide a four-wheel drive operation to the vehicle chassis. The vehicle also includes industry machinery or construction equipment supported upon the vehicle chassis. Other embodiments of this aspect include corresponding computer systems, apparatus, and computer programs recorded on one or more computer storage devices, each configured to perform the actions of the methods.

Implementations may include one or more of the following features. The land vehicle may include a second PMAC motor operably connected to the second hub and the second traction device to operate the second traction device to drive the vehicle chassis along the underlying surface. The land vehicle may include a second ACIM operably connected to the fourth hub and the fourth traction device to operate the fourth traction device to drive the vehicle chassis along the underlying surface. The first traction device and the second traction device are connected to the vehicle chassis to pivot about upright axes for steer of the vehicle chassis. Implementations of the described techniques may include hardware, a method or process, or computer software on a computer-accessible medium.

One general aspect includes a land vehicle. The land vehicle also includes a vehicle chassis having a longitudinal direction of travel. The vehicle also includes a first hub connected to the vehicle chassis for rotation relative to the vehicle chassis and to pivot about an upright axis for steer of the vehicle chassis. The vehicle also includes a second hub connected to the vehicle chassis for rotation relative to the vehicle chassis and to pivot about an upright axis for steer of the vehicle chassis, the second hub being transversely spaced apart from, and transversely aligned with, the first hub. The vehicle also includes a third hub connected to the vehicle chassis for rotation relative to the vehicle chassis, the third hub being longitudinally spaced apart from the first hub and the second hub. The vehicle also includes a fourth hub connected to the vehicle chassis for rotation relative to the vehicle chassis, the fourth hub being transversely spaced apart from, and transversely aligned with the third hub, and longitudinally spaced apart from the first hub and the second hub. The vehicle also includes a first traction device connected to the first hub to support the vehicle chassis for travel along an underlying surface. The vehicle also includes a second traction device connected to the second hub to support the vehicle chassis for travel along the underlying surface. The vehicle also includes a third traction device connected to the third hub to support the vehicle chassis for travel along the underlying surface. The vehicle also includes a fourth traction device connected to the fourth hub to support the vehicle chassis for travel along the underlying surface. The vehicle also includes a first permanent magnet alternating current (PMAC) motor operably connected to the first hub and the first traction device to operate the first traction device to drive the vehicle chassis along an underlying surface. The vehicle also includes a second PMAC motor operably connected to the second hub and the second traction device to operate the second traction device to drive the vehicle chassis along the underlying surface. The vehicle also includes a first alternating current induction motor (ACIM) operably connected to the third hub and the third traction device to operate the third traction device to drive the vehicle chassis along the underlying surface. The vehicle also includes a second ACIM operably connected to the fourth hub and the fourth traction device to operate the fourth traction device to drive the vehicle chassis along the underlying surface. The vehicle also includes a controller in operable communication with the first PMAC motor, the second PMAC motor, the first ACIM, and the second ACIM, the controller programmed to: maintain the first ACIM and the second ACIM in idle and operate the first PMAC motor and the second PMAC motor to provide a two-wheel drive operation to the vehicle chassis, and operate the first ACIM, the second ACIM, the first PMAC motor, and the second PMAC motor to provide a four-wheel drive operation to the vehicle chassis. The vehicle also includes industry machinery or construction equipment supported upon the vehicle chassis. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a perspective of an aerial lift vehicle according to an embodiment, illustrated in a partially extended position;

FIG. 2 is a perspective view of an aerial lift vehicle according to another embodiment, illustrated partially extended; and

FIG. 3 is a top plan schematic view of a drive assembly for an aerial lift vehicle according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

It will also be understood that, although the terms first, second, etc. are, in some instances, used herein to describe various elements in order of introduction, these elements should not be limited by these terms. These terms are only used to distinguish one element from another. For example, a first motor could be termed a second motor, and, similarly, a second motor could be termed a first motor, without departing from the scope of the various described embodiments. The first motor and the second motor are both motors, but they are not the same motor.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”′ is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The terminology controller may be provided as one or more controllers or control modules for the various components and systems. The controller 96 and control system may include any number of controllers, and may be integrated into a single controller, or have various modules. Some or all of the controllers may be connected by a controller area network (CAN) or other system. It is recognized that any controller, circuit, or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

Aerial lift assemblies provide an operator platform on a linkage assembly that pivots and/or translates to lift the operator platform to an elevated worksite. Conventional aerial lift assemblies include various adjustable structures to lift an operator platform to a height for performing a work operation. The aerial lift assemblies often include a stack linkage assembly. The aerial lift assemblies often include an articulated boom assembly, which may be provided by a four-bar linkage mechanism or an extending riser type linkage. Aerial lift assemblies are often provided on land vehicles for transportation of operator platform to the worksite. Although aerial lift assemblies are illustrated and described, any industry machinery or construction equipment may be utilized.

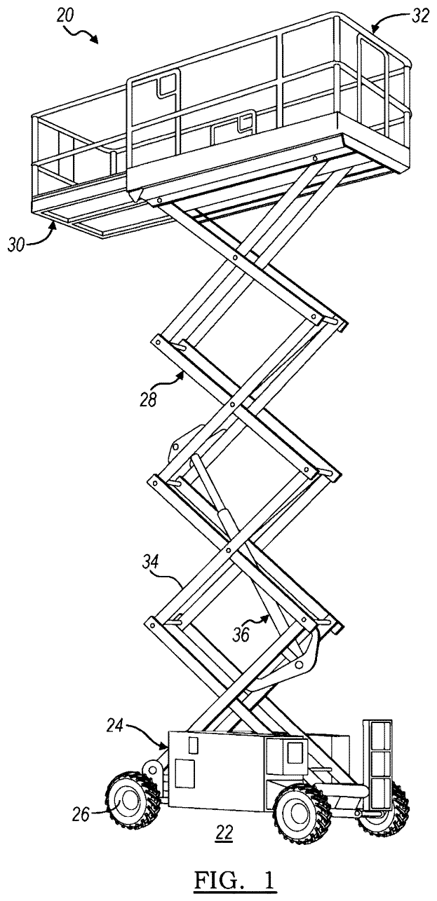

FIG. 1 illustrates an aerial lift assembly 20 according to an embodiment. The aerial lift assembly 20 is a mobile aerial lift assembly 20 as a land vehicle, which is collapsible for transportation upon an underlying support surface 22, such as the ground or a floor (FIG. 1). The aerial lift assembly 20 is also transportable for towing and transport upon a trailer behind a truck. The aerial lift assembly 20 is expandable by operator control to lift an operator to an elevated worksite. The aerial lift assembly 20 is discussed with relation to the ground 22. Therefore, terms such as upper, lower, and other height related terms are relative to height from the ground 22 are not to limit the aerial lift assembly 20 to ground 22 specific applications.

The aerial lift assembly 20 includes a lift structure that provides significant stability and performance characteristics by elevating a worker to an advantageous position for reach while providing stability. The aerial lift assembly 20 includes a chassis 24 to support the aerial lift assembly 20 upon the ground 22 or any support surface. The chassis 24 is supported upon a plurality of wheels 26 that contact the ground 22. A linkage assembly 28 is connected to the chassis 24 to extend and retract from the chassis 24. A platform 30 is provided on the linkage assembly 28 to extend and retract from the chassis 24. The platform 30 includes perimeter railing 32 extending upward from the platform 30 to enclose an operator workspace upon the platform 30.

The aerial lift assembly 20 is utilized to lift the platform 30 and workers to elevated work locations to perform work operations. The linkage assembly 28 is a stack linkage assembly 28, with a series of pivotally connected stack links 34 that retract to collapse and stack upon the chassis 24 for compactness for storage and transportation. The aerial lift assembly 20 also includes an actuator assembly 36 to extend and retract the linkage assembly 28 and consequently, extend and retract the platform 30.

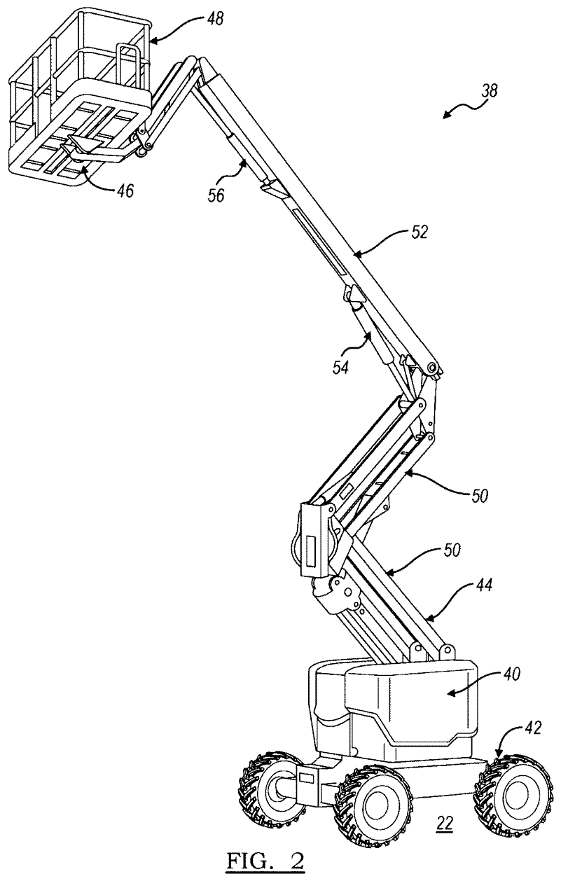

FIG. 2 illustrates an aerial lift assembly 38 according to another embodiment. The aerial lift assembly 38 includes a chassis 40 to support the aerial lift assembly 38 upon the ground 22. The chassis 40 is supported upon a plurality of wheels 42 that contact the ground 22 for support and mobility of the aerial lift assembly 38. A linkage assembly 44 is connected to the chassis 40 to extend and retract from the chassis 40. A platform 46 is provided on the linkage assembly 44 with a perimeter railing 48. The linkage assembly 44 includes a plurality of four bar linkages 50 with an extendable boom 52. Actuator assemblies 54 are provided to pivot the four bar linkages 50 and the extendable boom 52. An actuator assembly 56 is provided to extend the boom 52.

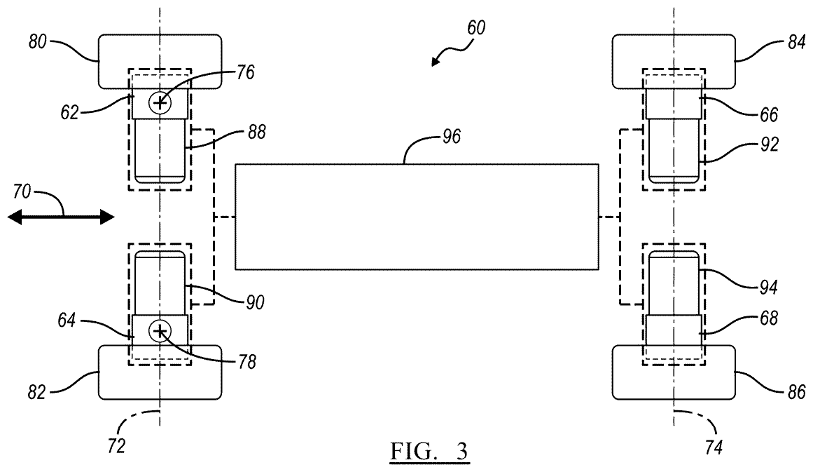

FIG. 3 illustrates a schematic, or architecture, of a drive assembly 60 according to an embodiment. The drive assembly 60 is for industry machinery and/or construction equipment, such as the aerial lift assemblies 20, 38 of prior embodiments. Other suitable land vehicles include forklifts, wheel-loaders, wheel-excavators, and the like. The drive assembly 60 is an electrical drive assembly 60. The drive assembly 60 cooperates with one of the chassis 24, 40 as a vehicle subassembly.

The drive assembly 60 includes four hubs 62, 64, 66, 68, each connected to the chassis 24, 40 for rotation relative to the chassis 24, 40. The vehicle chassis 24, 40 has a longitudinal direction 70 of travel. The hubs 62, 64 are mounted to the chassis 24, 40 for rotation about a horizontal axis 72 that is perpendicular to the direction 70 of travel. The hubs 66, 68 are mounted to the chassis 24, 40 for rotation about a horizontal axis 74 that is also perpendicular to the direction 70 of travel. The second hub 64 is transversely spaced apart from the first hub 62, and transversely aligned with the first hub 62 along the axis 72. The third hub 66 is longitudinally spaced apart from the first hub 62 and the second hub 64. The fourth hub 68 is also longitudinally spaced apart from the first hub 62 and the second hub 64. The fourth hub 68 is transversely spaced apart from the third hub 66. The fourth hub 68 is transversely aligned with the third hub 66 on the axis 74.

The first hub 62 is also pivotally connected to the chassis 24, 40 to pivot about an upright axis 76. Likewise, second hub 64 is pivotally connected to the chassis 24, 40 to pivot about another upright axis 78 spaced transversely from the first upright axis 76. The first hub 62 and the second hub 64 are rotated together, mechanically, or electronically, for steering of the vehicle chassis 24, 40.

A plurality of traction devices 80, 82, 84, 86 are provided, each mounted on one of the hubs 62, 64, 66, 68 for rotation relative to the chassis 24, 40 with the hubs 62, 64, 66, 68. According to an embodiment, the traction devices 80, 82, 84, 86 are wheels 80, 82, 84, 86. The wheels 80, 82, 84, 86 contact the underlying support surface 22 and support the chassis 24, 40 above the support surface 22. Rotation of the hubs 62, 64, 66, 68 and wheels 80, 82, 84, 86 results in translation of the vehicle chassis 24, 40 along the support surface 22.

The drive system 60 includes a plurality of motors 88, 90, 92, 94 to provide an electrical four wheel drive operation to the vehicle 20, 38. Each of the motors 88, 90, 92, 94 are connected to the chassis 24, 40 and one of the hubs 62, 64, 66, 68 to drive the hubs 62, 64, 66, 68 for rotation relative to the chassis 24, 40. The motors 88, 90, 92, 94 may be wheel-drive hub motors 88, 90, 92, 94.

The first two motors 88, 90 are permanent magnet alternating current (PMAC) motors 88, 90. The second pair of motors 92, 94 are alternating current induction motors (PMAC) 92, 94. Although two pairs of motors 88, 90, 92, 94 are illustrated and described, one motor 88 may be provided to drive the first pair of hubs 62, 64; and a second motor 92 may be provided to drive the second pair of hubs 66, 68.

In an ACIM 92, 94, current is induced into a rotor from a field (stator) through an air gap and conducted through bars (such as aluminum), which are often die cast in slots of rotor laminations. In a PMAC motor 88, 90, the rotor itself contains permanent magnet material, which is either surface-mounted to a rotor lamination stack or embedded within rotor laminations. In both motor styles 88, 90, 92, 94, electrical power is supplied through stator windings.

PMAC motors 88, 90 rotate at the same speed as the magnetic field produced by the stator windings, meaning the motors 88, 90 are synchronous. Conversely, ACIMs 92, 94 are asynchronous. Rotational speed of ACIMs 92, 94 is slightly less than the magnetic field, known as slip. The synchronization of PMAC motors 88, 90 results in improved efficiency, better dynamic performance, increased power, and more precise speed control. The PMAC motors 88, 90 provide higher flux density than comparable ACIMs 92, 94, thereby providing more torque for a similar sized motor 88, 90. PMAC motors 88, 90 also operate at a lower operating temperature, with reduced vibration and noise, and improved reliability, while saving energy. PMAC motors 88, 90 require less frequent maintenance and offer longer bearing and insulation life.

Conversely, ACIMs 92, 94 provide advantages over PMAC motors 88, 90. ACIMs 92, 94 generally cost less than PMAC motors 88, 90, due to the absence of costly rare-earth magnets and simpler construction. The use of rare earth materials can pose supply chain risks as well as higher costs. ACIMs 92, 94 are known for their robustness, ruggedness, durability, and ability to operate in harsh environments. ACIMs 92, 94 have fewer components that are sensitive to environmental factors, which can make ACIMs 92, 94 more reliable and longer lasting. ACIMs 92, 94 typically require less maintenance compared to PMAC motors 88, 90, because ACIMs 92, 94 do not have brushes or permanent magnets, which can wear out or degrade over time. The design of ACIMs 92, 94 is simpler, which often translates to casier manufacturing and potentially lower costs. Additionally, the lack of permanent magnets simplifies the motor's electrical control and operational requirements. ACIMs 92, 94 can generally tolerate a wider range of temperatures compared to PMAC motors 88, 90. Permanent magnets can lose magnetic properties if exposed to high temperatures, which can affect the performance of the PMAC motors 88, 90. ACIMs 92, 94 can handle overload conditions better than PMAC motors 88, 90. The ACIMs 92, 94 ability to permit rotor slip under load can help the ACIMs 92, 94 manage short-term overloads without immediate damage. While both types of motors 88, 90, 92, 94 can be used in variable-speed applications, ACIMs 92, 94 are well-suited for a wide range of speeds and can be readily controlled using variable frequency drives (VFDs).

The drive assembly 60 includes a controller 96 in operable communication with the PMAC motors 88, 90 and the ACIMs 92, 94. The controller 96 is programmed to operate the drive assembly 60 in a two wheel drive operation and in a four wheel drive operation. When the drive assembly 60 is operated in the two wheel drive mode, the controller 96 operates the PMAC motors 88, 90 to produce torque to drive the vehicle 20, 38. In the two wheel drive mode, the controller 96 maintains the ACIMs 92, 94 in idle to not produce any torque, and to not resist rotation of the hubs 66, 68. When the drive assembly 60 is in four wheel drive mode, the controller 96 operates the PMAC motors 88, 90 and the ACIMs 92, 94 to provide torque for driving the vehicle 20, 38. The drive assembly 60 provides an ability to shift between two wheel drive mode and four wheel drive mode, as may be required for a particular travel application.

According to an embodiment, individual wheel drive is provided for each wheel 80, 82, 84, 86 with the four motors 88, 90, 92, 94. If two pairs of drivetrains are integrated with two individual wheel drive for two wheels (80, 82, or 84, 86) according to another embodiment, or if one drivetrain is integrated with four wheel drive for the four wheels 80, 82, 84, 86 according to another embodiment, the number of individual wheel drive is four wheels 80, 82, 84, 86.

In a transverse direction 72, 74 of the drive assembly 60, the two same type motors (PMAC or ACIM) are used in each wheel (80, 82, or 84, 86). For example, the motors 88, 90 in the transverse direction 72, are the same type of motor, such as the PMAC motors 88, 90. Likewise, the motors 92, 94 are the same type of motor-ACIMs 92, 94 and are in the same transverse direction 74.

For two wheel drive mode, the two PMAC motors 88, 90 in the transverse direction 72 are in a power mode and the two ACIMs 92, 94 in the transverse direction 74 are in idle status.

With two PMAC motors 88, 90, it is advantageous to install the motors 88, 90 for steering, according to one example.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A drive assembly comprising:
a permanent magnet alternating current (PMAC) motor adapted to be operably connected to a vehicle chassis and a first traction device to operate the first traction device to drive the vehicle chassis along an underlying surface; and
an alternating current induction motor (ACIM) adapted to be operably connected to the vehicle chassis and a second traction device to operate the second traction device to drive the vehicle chassis along the underlying surface.

2. The drive assembly of claim 1, further comprising a controller in operable communication with the PMAC motor and the ACIM, the controller programmed to:
maintain the ACIM in idle and operate the PMAC motor to provide a two-wheel drive operation to the vehicle chassis.

3. The drive assembly of claim 2, wherein the controller further comprises memory.

4. The drive assembly of claim 1, further comprising a controller in operable communication with the PMAC motor and the ACIM, the controller programmed to:
operate the ACIM and operate the PMAC motor to provide a four-wheel drive operation to the vehicle chassis.

5. A vehicle subassembly comprising:
a vehicle chassis;
a plurality of traction devices connected to the vehicle chassis to support the vehicle chassis for travel along an underlying surface; and
the drive assembly of claim 1, wherein the PMAC motor is operably connected to the vehicle chassis and a first traction device of the plurality of traction devices, and wherein the ACIM is operably connected to the vehicle chassis and a second traction device of the plurality of traction devices.

6. The vehicle subassembly of claim 5, wherein the first traction device further comprises a pair of wheels.

7. The vehicle subassembly of claim 5, wherein the second traction device further comprises a pair of wheels.

8. The vehicle subassembly of claim 5, wherein the first traction device is connected to the vehicle chassis to pivot about an upright axis for steer of the vehicle chassis.

9. The vehicle subassembly of claim 5, further comprising a first hub connected to the vehicle chassis for rotation relative to the vehicle chassis;
wherein the first traction device further comprises a first wheel mounted to the first hub; and
wherein the PMAC motor is operably connected to the first hub.

10. The vehicle subassembly of claim 9, further comprising a second hub connected to the vehicle chassis for rotation relative to the vehicle chassis;
wherein the second traction device further comprises a second wheel mounted to the second hub; and
wherein the ACIM is operably connected to the second hub.

11. A land vehicle comprising:
the vehicle subassembly of claim 5; and
industry machinery or construction equipment supported upon the vehicle chassis.

12. The land vehicle of claim 11, wherein the industry machinery or construction equipment further comprises an aerial lift.

13. A land vehicle comprising:
a vehicle chassis having a longitudinal direction of travel;
a first hub connected to the vehicle chassis for rotation relative to the vehicle chassis;
a second hub connected to the vehicle chassis for rotation relative to the vehicle chassis, the second hub being transversely spaced apart from, and transversely aligned with, the first hub;
a third hub connected to the vehicle chassis for rotation relative to the vehicle chassis, the third hub being longitudinally spaced apart from the first hub and the second hub;
a fourth hub connected to the vehicle chassis for rotation relative to the vehicle chassis, the fourth hub being transversely spaced apart from, and transversely aligned with the third hub, and longitudinally spaced apart from the first hub and the second hub;
a first traction device connected to the first hub to support the vehicle chassis for travel along an underlying surface;
a second traction device connected to the second hub to support the vehicle chassis for travel along the underlying surface;
a third traction device connected to the third hub to support the vehicle chassis for travel along the underlying surface;
a fourth traction device connected to the fourth hub to support the vehicle chassis for travel along the underlying surface;
a first permanent magnet alternating current (PMAC) motor operably connected to the first hub and the first traction device to operate the first traction device to drive the vehicle chassis along an underlying surface;
a second PMAC motor operably connected to the second hub and the second traction device to operate the second traction device to drive the vehicle chassis along the underlying surface;
a first alternating current induction motor (ACIM) operably connected to the third hub and the third traction device to operate the third traction device to drive the vehicle chassis along the underlying surface;
a second ACIM operably connected to the fourth hub and the fourth traction device to operate the fourth traction device to drive the vehicle chassis along the underlying surface;
a controller in operable communication with the first PMAC motor, the second PMAC motor, the first ACIM, and the second ACIM, the controller programmed to:
maintain the first ACIM and the second ACIM in idle and operate the first PMAC motor and the second PMAC motor to provide a two-wheel drive operation to the vehicle chassis, and
operate the first ACIM and the second ACIM, and operate the first PMAC motor and the second PMAC motor to provide a four-wheel drive operation to the vehicle chassis; and
industry machinery or construction equipment supported upon the vehicle chassis.

14. The land vehicle of claim 13, wherein the first traction device and the second traction device are connected to the vehicle chassis to pivot about upright axes for steer of the vehicle chassis.

15. A land vehicle comprising:
a vehicle chassis having a longitudinal direction of travel;
a first hub connected to the vehicle chassis for rotation relative to the vehicle chassis and to pivot about an upright axis for steer of the vehicle chassis;
a second hub connected to the vehicle chassis for rotation relative to the vehicle chassis and to pivot about an upright axis for steer of the vehicle chassis, the second hub being transversely spaced apart from, and transversely aligned with, the first hub;
a third hub connected to the vehicle chassis for rotation relative to the vehicle chassis, the third hub being longitudinally spaced apart from the first hub and the second hub;
a fourth hub connected to the vehicle chassis for rotation relative to the vehicle chassis, the fourth hub being transversely spaced apart from, and transversely aligned with the third hub, and longitudinally spaced apart from the first hub and the second hub;
a first traction device connected to the first hub to support the vehicle chassis for travel along an underlying surface;
a second traction device connected to the second hub to support the vehicle chassis for travel along the underlying surface;
a third traction device connected to the third hub to support the vehicle chassis for travel along the underlying surface;
a fourth traction device connected to the fourth hub to support the vehicle chassis for travel along the underlying surface;
a first permanent magnet alternating current (PMAC) motor operably connected to the first hub and the first traction device to operate the first traction device to drive the vehicle chassis along an underlying surface;
a second PMAC motor operably connected to the second hub and the second traction device to operate the second traction device to drive the vehicle chassis along the underlying surface;
a first alternating current induction motor (ACIM) operably connected to the third hub and the third traction device to operate the third traction device to drive the vehicle chassis along the underlying surface;
a second ACIM operably connected to the fourth hub and the fourth traction device to operate the fourth traction device to drive the vehicle chassis along the underlying surface;
a controller in operable communication with the first PMAC motor, the second PMAC motor, the first ACIM, and the second ACIM, the controller programmed to:
maintain the first ACIM and the second ACIM in idle and operate the first PMAC motor and the second PMAC motor to provide a two-wheel drive operation to the vehicle chassis, and
operate the first ACIM, the second ACIM, the first PMAC motor, and the second PMAC motor to provide a four-wheel drive operation to the vehicle chassis; and
industry machinery or construction equipment supported upon the vehicle chassis.
